(19) United States
(12) Patent Application Publication
(10) Pub. No.: US 2013/0273429 A1
(43) Pub. Date: Oct. 17, 2013

(54) NON-AQUEOUS ELECTROLYTE SECONDARY BATTERY

(71) Applicant: Denis Yu, Singapore (SG)

(72) Inventor: Denis Yu, Singapore (SG)

(73) Assignee: SANYO ELECTRIC CO., LTD., Moriguchi-shi, Osaka (JP)

(21) Appl. No.: 13/976,660

(22) PCT Filed: Feb. 28, 2012
(86) PCT No.: PCT/JP2012/054864

§ 371 Date: Jun. 27, 2013

(30) Foreign Application Priority Data
Feb. 28, 2011 (JP) 2011-041295

(51) Int. Cl. H01M 4/131

(52) U.S. Cl. CPC H01M 4/131
USPC 429/223; 429/224

(57) ABSTRACT

In nonaqueous electrolyte secondary batteries whose positive electrode includes a positive electrode active material containing a lithium-excess transition metal oxide, the charge-discharge cycle characteristics are improved. The positive electrode active material contains a first active material represented by general formula LiCoₓM₁₋ₓO₂ (0.3≦x≦0.7, M is at least one transition metal element and includes at least Ni or Mn) and a second active material represented by general formula Li_{1+y}Mn_{1-y-z}A₂O<y<0.4, 0<z<0.6, A is at least one transition metal element and includes at least Ni or Co).

### TECHNICAL FIELD

The present invention relates to a nonaqueous electrolyte secondary battery and a positive electrode for nonaqueous electrolyte secondary batteries.

### BACKGROUND ART

With an increase in power consumption of mobile devices, the capacity of nonaqueous electrolyte secondary batteries used as a power source has been increasing every year.

A lithium transition metal oxide represented by general formula Li_{1+α}Mn_{1-α-β}M_{β}O₂ (M is at least one transition metal other than Mn) has been known as one of high-capacity positive electrode active materials. In the present invention, among the lithium transition metal oxides represented by the general formula above, lithium transition metal oxides that satisfy α>0 are referred to as lithium-excess transition metal oxides. Research results regarding Li(Ni_{0.58}Mn_{0.18}Co_{0.15}Li_{0.09})O₂ which is one of the lithium-excess transition metal oxides have been reported by Thackeray et al. (PTL 1).

### CITATION LIST

### Patent Literature

PTL 1: U.S. Pat. No. 6,680,143

### SUMMARY OF INVENTION

### Technical Problem

In nonaqueous electrolyte secondary batteries whose positive electrode includes a positive electrode active material containing a lithium-excess transition metal oxide, the charge-discharge cycle characteristics are improved.

### Solution to Problem

A nonaqueous electrolyte secondary battery according to a first aspect of the present invention includes a positive electrode containing a positive electrode active material, a negative electrode, and a nonaqueous electrolyte. In the nonaqueous electrolyte secondary battery, the positive electrode active material contains a first active material represented by general formula LiCoₓM₁₋ₓO₂ (0.3≦x≦0.7, M is at least one transition metal element and includes at least Ni or Mn) and a second active material represented by general formula Li_{1+y}Mn_{1-y-z}A_{z}O₂O₂ (0<y<0.4, 0<z<0.6, A is at least one transition metal element and includes at least Ni or Co).

An example of the first active material is an active material represented by general formula LiCoₐNi_{b}Ni_{b}Mn_{c}O₂ (0.3≦a≦0.7, 0.1<b<0.4, 0.1<c<0.4, a+b+c=1).

An example of the second active material is an active material represented by general formula Li_{1+d}MnₑNi_{f}Co_{g}Oₕ (021 d<0.4, 0.4<e<1.0≦f<0.4, 0≦g<0.4, 1.9<h<2.1, d+e+f+g=1).

A nonaqueous electrolyte that has been used for existing nonaqueous electrolyte secondary batteries can be employed as a nonaqueous electrolyte used in the present invention. An example of the nonaqueous electrolyte is a mixture of ethylene carbonate and diethyl carbonate. Fluoroethylene carbonate, acetonitrile, or methyl propionate may be added to the nonaqueous electrolyte.

The nonaqueous electrolyte used in the present invention contains a lithium salt that has been used for existing nonaqueous electrolyte secondary batteries. Examples of the lithium salt include LiPF₆ and LiBF₄.

A negative electrode active material that has been used for existing nonaqueous electrolyte secondary batteries can be employed as a negative electrode active material used in the present invention. Examples of the negative electrode active material include natural graphite, artificial graphite, lithium, silicon, and silicon alloys.

Battery components that have been used for existing nonaqueous electrolyte secondary batteries may be optionally used for the nonaqueous electrolyte secondary battery of the present invention.

### Advantageous Effects of Invention

According to the present invention, in nonaqueous electrolyte secondary batteries whose positive electrode includes a positive electrode active material containing a lithium-excess transition metal oxide, the charge-discharge cycle characteristics can be improved.

### BRIEF DESCRIPTION OF DRAWING

FIG. 1 is a schematic view of a three-electrode cell produced in Examples and Comparative Examples.

### DESCRIPTION OF EMBODIMENTS

The present invention will now be described in detail based on EXAMPLES. Note that the present invention is not limited by EXAMPLES below, and can be suitably modified without departing from the scope of the present invention.

### EXAMPLES

### [Production of Positive Electrode]

### Example 1

Lithium hydroxide (LiOH) was added to an aqueous solution containing Ni, Co, and Mn to prepare nickel-cobalt-manganese (NiCoMn) hydroxide. The nickel-cobalt-manganese hydroxide and lithium carbonate were mixed with each other so as to satisfy a stoichiometric ratio of LiNi_{0.15}Co_{0.70}Mn_{0.15}O₂. The mixture was then fired in the air at 900° C. for 24 hours to produce a first active material.

The particle size of the first active material was measured using a laser diffraction particle size analyzer, and the average particle size (D₅₀) was 12 μm. The average particle size (D₅₀) was defined as the particle size at which, when the numbers of particles are accumulated in ascending order of particle size, the cumulative number reaches 50% of the total number of particles.

As a result of the analysis of the first active material by powder X-ray diffraction, it was confirmed that the first active material had a layered structure that belongs to the space group R3-m.

Lithium hydroxide (LiOH) was added to an aqueous solution containing Ni, Co, and Mn to prepare nickel-cobalt-manganese hydroxide. The nickel-cobalt-manganese hydroxide and lithium carbonate were mixed with each other so as to satisfy a stoichiometric ratio of Li_{1.2}Mn_{0.54}Ni_{0.13}Co_{0.13}O₂. The mixture was then fired in the air at 900° C. for 24 hours to produce a second active material.

The particle size of the second active material was measured in the same manner as described above, and the average particle size (D₅₀) was 6 μm. As a result of the analysis of the second active material by powder X-ray diffraction, it was confirmed that the second active material had a layered structure that belongs to the space group C2/m and a layered structure that belongs to the space group R3-m.

The first active material and the second active material were mixed with each other at a mass ratio of 5:5. The mixed positive electrode active material, acetylene black, and polyvinylidene fluoride were mixed with each other at a mass ratio of 90:5:5. N-methyl-2-pyrrolidone (NMP) was then added to the mixture to prepare a slurry. The slurry was applied onto a current collector made of aluminum foil and dried in the air at 120° C. to produce an electrode. The obtained electrode was rolled and cut into pieces each having a size of 20 mm×50 mm to produce a positive electrode a1.

### Example 2

A positive electrode a2 was produced in the same manner as in Example 1, except that, in the production process of the first active material, the nickel-cobalt-manganese hydroxide and lithium carbonate were mixed with each other so as to satisfy a stoichiometric ratio of LiCo_{0.50}Ni_{0.25}Mn_{0.25}O₂. The particle size of the first active material was measured in the same manner as described above, and the average particle size (D₅₀) was 12 μm. As a result of the analysis of the first active material by powder X-ray diffraction, it was confirmed that the first active material had a layered structure that belongs to the space group R3-m.

### Example 3

A positive electrode a3 was produced in the same manner as in Example 1, except that, in the production process of the first active material, the nickel-cobalt-manganese hydroxide and lithium carbonate were mixed with each other so as to satisfy a stoichiometric ratio of LiCo_{1/3}Ni_{1/3}Mn_{1/3}O₂. The particle size of the first active material was measured in the same manner as described above, and the average particle size (D₅₀) was 12 μm. As a result of the analysis of the first active material by powder X-ray diffraction, it was confirmed that the first active material had a layered structure that belongs to the space group R3-m.

### Comparative Example 1

A positive electrode b1 was produced in the same manner as in Example 1, except that, in the production process of the first active material, LiCO₂ and CO₂O₄ were mixed with each other so as to satisfy a stoichiometric ratio of LiCoO₂. The particle size of the first active material was measured in the same manner as described above, and the average particle size (D₅₀) was 12 μm. As a result of the analysis of the first active material by powder X-ray diffraction, it was confirmed that the first active material had a layered structure that belongs to the space group R3-m.

### Comparative Example 2

A positive electrode b2 was produced in the same manner as in Example 1, except that only the second active material in Example 1 was used as a positive electrode active material.

### Comparative Example 3

A positive electrode b3 was produced in the same manner as in Example 1, except that only the first active material in Example 1 was used as a positive electrode active material.

### Comparative Example 4

A positive electrode b4 was produced in the same manner as in Example 2, except that only the first active material in Example 2 was used as a positive electrode active material.

### Comparative Example 5

A positive electrode b5 was produced in the same manner as in Example 3, except that only the first active material in Example 3 was used as a positive electrode active material.

### Comparative Example 6

A positive electrode b6 was produced in the same manner as in Comparative Example 1, except that only the first active material in Comparative Example 1 was used as a positive electrode active material.

### [Production of Three-electrode Cell]

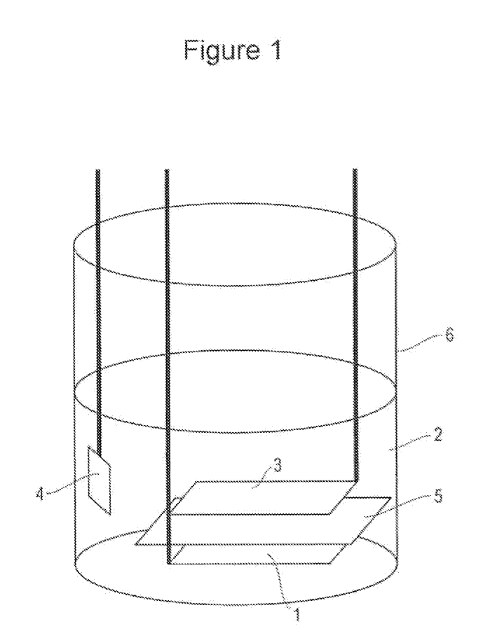

Three-electrode cells A1 to A3 and B1 to B6 shown in FIG. 1 were produced using the positive electrodes a1 to a3 and b1 to b6, respectively. The positive electrodes a1 to a3 and b1 to b6 were each used as a working electrode 1. A nonaqueous electrolyte 2 was prepared by dissolving LiPF₆, in a concentration of 1 mol/L, in a nonaqueous electrolytic solution which was prepared by mixing ethylene carbonate with diethyl carbonate at a volume ratio of 3:7. Lithium metal was used as a counter electrode 3 and a reference electrode 4. A polyethylene separator was used as a separator 5.

### [Charge-discharge Cycle Test]

The three-electrode cells A1 to A3 and B1 to B6 were each charged at room temperature at a constant current of 100 mA/g until the working electrode potential on a reference electrode basis reached 4.6 V (Li/Li⁺), charged at a constant voltage of 4.6 V (Li/Li⁺) until the current value reached 5 mA/g, and then discharged at a constant current of 100 mA/g until the working electrode potential on a reference electrode basis reached 2 V (Li/Li⁺). The discharge capacity at this time was defined as a discharge capacity of the 1st cycle. The charge-discharge operation was further repeatedly performed 28 times under the same conditions. The capacity retention ratio after the charge-discharge cycle test was determined by dividing the discharge capacity of the 29th cycle by the discharge capacity of the 1st cycle. Table 1 shows the results.

TABLE 1

| | | | Capac- |
|---|---|---|---|
| Three- | | | ity re- |
| elec- | | | tention |
| trode | | | ratio |
| cell | First active material | Second active material | (%) |
| A1 | LiCo_{0.70}Ni_{0.15}Mn_{0.15}O₂ | Li_{1.2}Mn_{0.54}Ni_{0.13}Co_{0.13}O₂ | 88.7 |
| A2 | LiCo_{0.50}Ni_{0.25}Mn_{0.25}O₂ | Li_{1.2}Mn_{0.54}Ni_{0.13}Co_{0.13}O₂ | 91.6 |
| A3 | LiCo_{1/3}Ni_{1/3}Mn_{1/3}O₂ | Li_{1.2}Mn_{0.54}Ni_{0.13}Co_{0.13}O₂ | 87.6 |
| B1 | LiCoO₂ | Li_{1.2}Mn_{0.54}Ni_{0.13}Co_{0.13}O₂ | 73.3 |
| B2 | — | Li_{1.2}Mn_{0.54}Ni_{0.13}Co_{0.13}O₂ | 76.1 |
| B3 | LiCo_{0.70}Ni_{0.15}Mn_{0.15}O₂ | — | 68.0 |
| B4 | LiCo_{0.50}Ni_{0.25}Mn_{0.25}O₂ | — | 77.3 |
| B5 | LiCo_{1/3}Ni_{1/3}Mn_{1/3}O₂ | — | 74.0 |
| B6 | LiCoO₂ | — | 43.7 |

As is clear from Table 1, the capacity retention ratio of A1 that contains both the first active material and second active material is higher than the capacity retention ratio of B2 that contains only the second active material and the capacity retention ratio of B3 that contains only the first active material. Thus, it is found that, when the positive electrode active material contains both the first active material and second active material, a larger-than-expected effect is produced due to the combined effect of the first and second active materials. It is also found that such a larger-than-expected effect is also produced in A2 and A3.

It is clear that the capacity retention ratios of A1 to A3 are higher than the capacity retention ratio of B1. This means that a high capacity retention ratio is achieved when x in the general formula of the first active material is 0.7 or less. The reason for this is unclear, but is believed to be as follows. The first active material of B1 contains a large amount of Co and thus the reactivity between a positive electrode and an electrolytic solution is increased. As a result, the electrolytic solution is excessively decomposed and the capacity retention ratio of B1 is decreased. Herein, in the case where the positive electrode is charged to 4.5 V (Li/Li±) or more on a lithium metal basis, the above-described reactivity between a positive electrode and an electrolytic solution is believed to be further increased.

### Example 4

The nickel-cobalt-manganese hydroxide and lithium carbonate were mixed with each other so as to satisfy a stoichiometric ratio of LiCo_{1/3}Ni_{1/3}Mn_{1/3}O₂. The mixture was then fired in the air at 900° C. for 24 hours to produce a first active material.

The particle size of the first active material was measured in the same manner as described above, and the average particle size (D₅₀) was 14.1 μm. As a result of the analysis of the first active material by powder X-ray diffraction, it was confirmed that the first active material had a layered structure that belongs to the space group R3-m.

The nickel-cobalt-manganese hydroxide and lithium carbonate were mixed with each other so as to satisfy a stoichiometric ratio of Li_{1.2}Mn_{0.54}Ni_{0.13}Co_{0.13}O₂. The mixture was then fired in the air at 900° C. for 24 hours to produce a second active material.

The particle size of the second active material was measured in the same manner as described above, and the average particle size (D₅₀) was 12.7 μm. As a result of the analysis of the second active material by powder X-ray diffraction, it was confirmed that the second active material had a layered structure that belongs to the space group C2/m and a layered structure that belongs to the space group R3-m.

The first active material and the second active material were mixed with each other at a mass ratio of 8:2. Subsequently, a three-electrode cell A4 was produced in the same manner as in Example 1.

### Example 5

A three-electrode cell A5 was produced in the same manner as in Example 4, except that the first active material and the second active material were mixed with each other at a mass ratio of 6:4.

### Example 6

A three-electrode cell A6 was produced in the same manner as in Example 4, except that the first active material and the second active material were mixed with each other at a mass ratio of 4:6.

### Example 7

A three-electrode cell A7 was produced in the same manner as in Example 4, except that the first active material and the second active material were mixed with each other at a mass ratio of 2:8.

### Comparative Example 7

A three-electrode cell B7 was produced in the same manner as in Example 4, except that only the first active material in Example 4 was used as a positive electrode active material.

### Comparative Example 8

A three-electrode cell B8 was produced in the same manner as in Example 4, except that only the second active material in Example 4 was used as a positive electrode active material.

The three-electrode cells A4 to A7, B7, and B8 were subjected to the charge-discharge test in the same manner as described above. Table 2 shows the results.

TABLE 2

| Three- | Mass ratio of | Mass ratio of | Capacity |
|---|---|---|---|
| electrode | first active | second active | retention |
| cell | material (%) | material (%) | ratio (%) |
| A4 | 80 | 20 | 81.6 |
| A5 | 60 | 40 | 85.2 |
| A6 | 40 | 60 | 89.9 |
| A7 | 20 | 80 | 77.5 |
| B7 | 100 | 0 | 74.0 |
| B8 | 0 | 100 | 76.1 |

As is clear from Table 2, a high capacity retention ratio is achieved when the ratio of the mass of the first active material to the total mass of the first active material and second active material is 20% to 80% by mass.

### Example 8

The nickel-cobalt-manganese hydroxide and lithium carbonate were mixed with each other so as to satisfy a stoichiometric ratio of LiNi_{1/3}Co_{1/3}Mn_{1/3}O₂. The mixture was then fired in the air at 900° C. for 24 hours to produce a first active material. The particle size of the first active material was measured in the same manner as described above, and the average particle size (D₅₀) was 14.1 μm.

The nickel-cobalt-manganese hydroxide and lithium carbonate were mixed with each other so as to satisfy a stoichiometric ratio of Li_{1.2}Mn_{0.54}Ni_{0.13}Co_{0.13}O₂. The mixture was then fired in the air at 900° C. for 24 hours to produce a second active material. The particle size of the second active material was measured in the same manner as described above, and the average particle size (D₅₀) was 6.3 μm.

A positive electrode a8 was produced in the same manner as in Example 4, except that the obtained first active material and the obtained second active material were mixed with each other at a mass ratio of 8:2.

### Example 9

A positive electrode a9 was produced in the same manner as in Example 8, except that the first active material and the second active material were mixed with each other at a mass ratio of 6:4.

The mass (g), thickness (cm), and area (cm²) of each of the positive electrodes a4, a5, a8, and a9 were measured to calculate the packing density. The packing density was calculated from the following formula: Packing density=(mass of positive electrode−mass of current collector)/{(thickness of positive electrode−thickness of current collector)×area of positive electrode)}. Furthermore, between the average particle sizes (D₅₀) of the first active material and second active material, a large average particle size was denoted as R and a small average particle size was denoted as r, and a value of r/R was determined. Table 3 shows the results.

TABLE 3

| | Mass ratio of | Mass ratio of | | Packing |
|---|---|---|---|---|
| | first active | second active | | density |
| Electrode | material (%) | material (%) | r/R | (g/cm³) |
| a4 | 80 | 20 | 0.90 | 3.25 |
| a8 | 80 | 20 | 0.45 | 3.35 |
| a5 | 60 | 40 | 0.90 | 3.13 |
| a9 | 60 | 40 | 0.45 | 3.19 |

As is clear from Table 3, in the comparison between electrodes containing the first active material at the same mass ratio, a high packing density is achieved when 0.20<r/R<0.60 is satisfied.

### REFERENCE SIGNS LIST

1 working electrode

2 nonaqueous electrolyte

3 counter electrode

4 reference electrode

5 separator

6 container

1. A nonaqueous electrolyte secondary battery comprising a positive electrode containing a positive electrode active material, a negative electrode, and a nonaqueous electrolyte, wherein the positive electrode active material contains a first active material represented by general formula LiCoₓM₁₋ₓO₂ (0.3≦x≦0.7, M is at least one transition metal element and includes at least Ni or Mn) and a second active material represented by general formula Li_{1+y}Mn_{1-y-z}A_{z}O₂ (0<y<0.4, 0<z<0.6, A is at least one transition metal element and includes at least Ni or Co).

2. The nonaqueous electrolyte secondary battery according to claim 1, wherein a crystal structure of the first active material includes a layered structure that belongs to a space group R3-m.

3. The nonaqueous electrolyte secondary battery according to claim 1, wherein a crystal structure of the second active material includes a layered structure that belongs to at least a space group C2/C or C2/m.

4. The nonaqueous electrolyte secondary battery according to claim 1, wherein the first active material is represented by general formula LiCoₐNi_{b}Mn_{c}O₂ (0.3≦a0.7, 0.1<b<0.4, 0.1<c<0.4, a+b+c=1).

5. The nonaqueous electrolyte secondary battery according to claim 1, wherein the second active material is represented by general formula Li_{1+d}MnₑNi_{f}Co_{g}O₂ (0<d<0.4, 0.4<e<1.0f<0.4, 0≦g<0.4, d+e+f+g=1).

6. The nonaqueous electrolyte secondary battery according to claim 1, wherein a ratio of the mass of the first active material to the total mass of the first active material and second active material is 20% to 80% by mass.

7. The nonaqueous electrolyte secondary battery according to claim 1, wherein assuming that, between an average particle size (D₅₀) of the first active material and an average particle size (D₅₀) of the second active material, a large average particle size is denoted as R and a small average particle size is denoted as r, 0.20<r/R<0.60 is satisfied.

8. The nonaqueous electrolyte secondary battery according to claim 1, wherein the positive electrode is charged to 4.5 V (Li/Li⁺) or more on a lithium metal basis.

9. A positive electrode for nonaqueous electrolyte secondary batteries, comprising a positive electrode active material that contains a first active material represented by general formula LiCoₓM₁₋ₓO₂ (0.3≦x≦0.7, M is at least one transition metal element and includes at least Ni or Mn) and a second active material represented by general formula Li_{1+y}Mn_{1-y-z}A_{z}O₂ (0<y<0.4, 0<z<0.6, A is at least one transition metal element and includes at least Ni or Co).
